(19) United States
(12) Patent Application Publication
(10) Pub. No.: US 2022/0195977 A1
(43) Pub. Date: Jun. 23, 2022

(54) BUOYANCY WORKING DEVICE

(71) Applicant: Yongheng Cai, Jingmen (CN)

(72) Inventor: Yongheng Cai, Jingmen (CN)

(21) Appl. No.: 17/133,405

(22) Filed: Dec. 23, 2020

(51) Int. Cl. F03B 17/02

(52) U.S. Cl. CPC F03B 17/02

(57) ABSTRACT

A buoyancy working device includes a water tank with an opening and two arc-shaped guide rails, a rotating shaft, at least five support rods extending perpendicularly and evenly from the rotating shaft, an annular sealing ring connecting with the support rods and slidably connected with the two arc-shaped guide rails to seal the opening, hollow buoyant bodies (4) connecting with the sealing ring, and a gate assembly configured in the water tank to facilitate the hollow buoyant bodies to enter the water tank. The gate assembly includes a cylindrical main channel having an inner gate and an outer gate, a driving device for driving the inner gate and the outer gate, a pressure gas storage tank communicating with the main channel through a first pipe and a second pipe, a first one-way valve connected to the first pipe, and a second one-way valve connected to the second pipe.

### BACKGROUND OF THE INVENTION

### 1. Technical Field

The invention relates to a water energy utilization device, in particular to a buoyancy working device.

### 2. Description of Related Art

Liquids and gases have an upward supporting force on objects immersed therein, which is called buoyancy in physics. In scientific research, how to correctly use buoyancy for people has been an important subject for people to study. The existing hydro-generator is a device for converting potential energy of water into kinetic energy, and how to convert buoyancy applied to an object in water into power output is researched by the invention.

### BRIEF DESCRIPTION OF THE SEVERAL VIEWS OF THE DRAWINGS

The foregoing and other exemplary purposes, aspects and advantages of the present invention will be better understood in principle from the following detailed description of one or more exemplary embodiments of the invention with reference to the drawings, in which:

FIG. 1 is a schematic cross-sectional view showing a buoyancy working device in accordance with an embodiment of the present invention.

FIG. 2 is a schematic perspective view showing a part of a water tank of the buoyancy working device.

FIG. 3 is a schematic view showing a structure of an gate assembly of the buoyancy working device in accordance with an embodiment of the present embodiment.

FIG. 4 is a cross-sectional view showing an installation structure of a sealing ring of the buoyancy working device in accordance with an embodiment of the present embodiment.

FIG. 5 is a cross-sectional view showing an installation structure of a sealing ring of the buoyancy working device in accordance with another embodiment of the present embodiment.

### DETAILED DESCRIPTION OF THE INVENTION

The invention will now be described in detail through several embodiments with reference to the accompanying drawings.

A buoyancy working device disclosed in the embodiment mainly utilizes a buoyancy of water to form rotary motion output, and is also an energy conversion device from potential energy to kinetic energy.

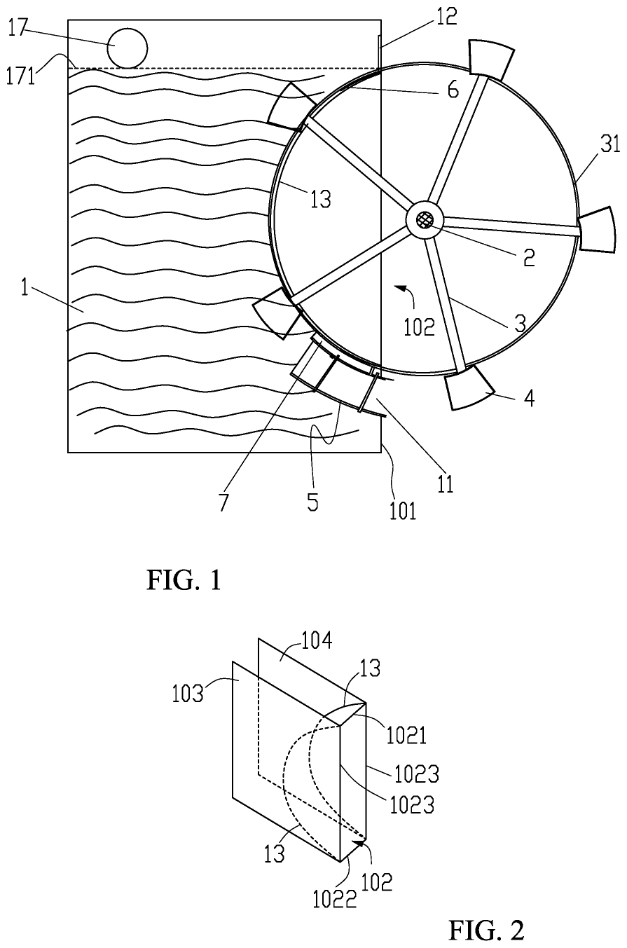

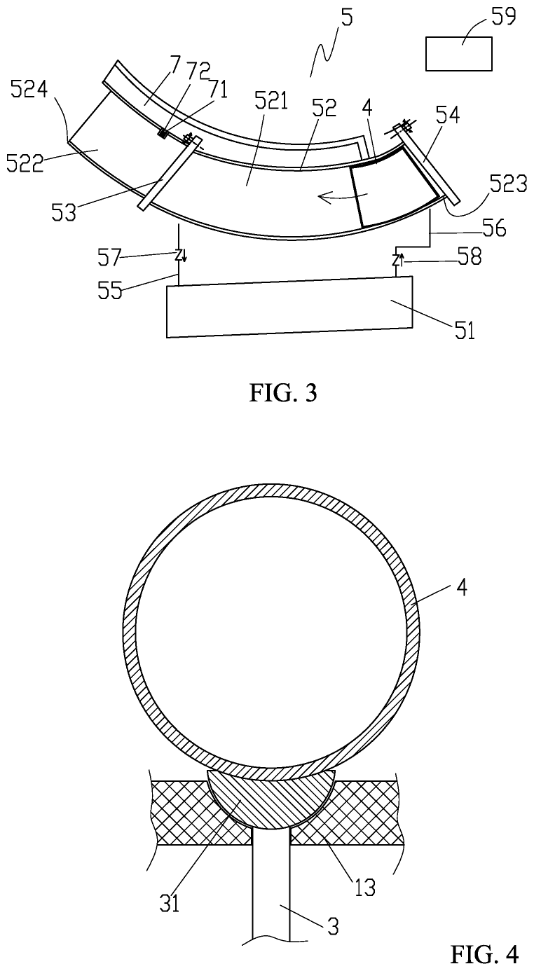

The buoyancy working device disclosed in the embodiment is particularly shown in FIGS. 1-4, including a water tank 1 and a rotating shaft 2 fixed outside the water tank 1. The water tank 1 is placed vertically, and has a side wall 101 defining a vertically narrow opening 102. In detail, in the embodiment, an upper edge 1021, a lower edge 1022 and two side edges 1023 form a rectangle frame defining the opening 102. Two parallel configured walls 103, 104 extend inwardly from the side edges 1023, respectively. Two arc-shaped guide rails 13 are fixed to an inner side of the walls 103, 104 respectively. An end of each arc-shaped guide rail 13 is connected to the upper edge 1021, and the other end of each arc-shaped guide rail 13 is connected to the lower edge 1022. The arc-shaped guide rail 13 may include a groove. In order to facilitate observation, part of the rails 13 and part of the wall 104 that should be blocked by the wall 103 are shown in perspective (in dashed lines) in FIG. 2, and the side wall 101 and other part of the water tank 1 are not shown.

The side wall 101 of the water tank 1 also defines an inlet 11 below the two guide rails 13 and an outlet 12 above the two guide rails 13. That is, the inlet 11 is below the lower edge 1022, and the outlet 12 is above the upper edge 1021.

The rotating shaft 2 is horizontally arranged near the side wall 101 of the water tank 1, and is perpendicular to the walls 103, 104. Five supporting rods 3 are uniformly distributed on the rotating shaft 2 in a radial mode. An annular sealing ring 31 is connected to ends of the five supporting rods 3, thus arranged around the rotating shaft 2. A radian of the sealing ring 31 is consistent with that of the arc-shaped guide rail 13. The sealing ring 31 is slidably and sealingly connected with the two arc-shaped guide rails 13 to seal the opening 102. Therefore, when the rotating shaft 2 rotates to move the sealing ring 31 to slide along the rails 13, water in the water tank 1 will not flow out through the opening 102.

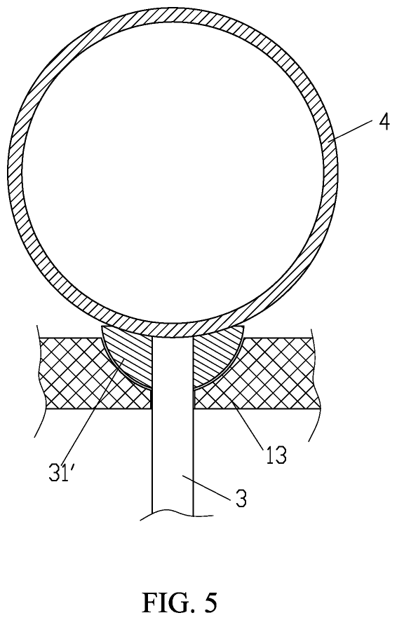

Five hollow buoyant bodies 4 are fixed on the sealing ring 31 or the ends of the supporting rods 3, and are located outside the sealing ring 31. The hollow buoyant bodies 4 are hollow balls in the embodiment. In other embodiments, the hollow buoyant bodies 4 may be fixed on the ends of the supporting rods 3, as shown in FIG. 5, and the supporting rods 3 pass through the sealing ring 31′ through holes defined in the sealing ring 31′.

In order to allow the hollow buoyant bodies 4 to smoothly enter the water tank 1, a gate assembly 5 for convenient entrance of the hollow buoyant bodies 4 into the water tank is installed in the water tank 1, close to the inlet 11.

The details are shown in FIG. 2. The gate assembly 5 includes a cylindrical main channel 52, the inner diameter of the main channel 52 is slightly larger than the outer diameter of the hollow buoyant body 4, so that the hollow buoyant body 4 does not have friction when passing through the main channel 52, and a gap between the hollow buoyant body 4 and the inner wall of the main channel 52 is not too large. An inner gate 53 and an outer gate 54 are arranged in the main channel 52. The outer gate 54 is arranged near or at an outer end 523 of the main channel 52, and the inner gate 53 is arranged near an inner end 524 of the main channel 52. Thus the main channel 52 is divided into a first section 521 between the inner gate 53 and the outer gate 54, and a second section 522 between the inner gate 53 and the inner end 524 of the main channel 52. The inner gate 53 and the outer gate 54 are driven by a driving device 59, a motor in the embodiment, to realize opening and closing. The inner gate 53 and the outer gate 54 move in the radial direction of the main channel 52 when the inner gate 53 and the outer gate 54 are open, which can reduce the pressure when opening, especially for the inner gate 53, which can reduce the resistance caused by the water pressure when opening. The main channel 52 close to the inner gate 53 is communicated with a pressure gas storage tank 51 through a first pipe 55, the main channel 52 close to the outer gate 54 is communicated with the pressure gas storage tank 51 through a second pipe 56. A first one-way valve 57 for controlling gas to enter the pressure gas storage tank 51 from the main channel 52 is arranged on the first pipe 55, and a second one-way valve 58 for controlling gas to enter the main channel 52 from the pressure gas storage tank 51 is arranged on the second pipe 56. The structure can increase the pressure of the pressure gas storage tank 51 during the movement of the hollow buoyant body 4 into the main channel 52 to the water tank 1, and push the hollow buoyant body 4 into the water tank 1 by releasing the pressure when the hollow buoyant body 4 enters the water tank 1 from the inner gate 53.

The inner gate 53 and the outer gate 54 in this embodiment are both normally closed gates. When the hollow buoyant body is close to the outer gate (photoelectric sensors or other position sensors may be used), the outer gate is driven by the motor to move transversely and automatically open, the hollow buoyant body automatically enter the main channel, during the movement process of the hollow buoyant body in the main channel, the one-way valve of the first pipe is opened, and gas in the main channel enters the pressure gas storage tank under the action of the hollow buoyant body, when the hollow buoyant body is close to the inner gate, the outer gate automatically closes, the gas outlet valve closes, the inner gate is driven by the motor to move transversely and automatically open, after the inner gate is completely opened, the one-way valve of the second pipe is opened, high-pressure gas in the pressure gas storage tank enters the main channel, together with the buoyancy ball in the water tank, to push the hollow buoyant body to enter the water tank from the inner gate, the hollow buoyant body entering the water tank is influenced by upward buoyancy of water, and the hollow buoyant body moves upward, the rotating shaft is thereby driven to rotate and other hollow buoyant bodies that do not enter the tank are driven to move.

In addition, in order to allow the hollow buoyant body to smoothly enter the water tank 1, an auxiliary channel 7 is provided. The auxiliary channel 7 is arranged near the main channel 52 and is connected with the second section 522 of the main channel 52 via a third pipe 71. A third valve 72 is connected on the third pipe 71 and is used for controlling water flow through the third pipe. Thus the auxiliary channel 7 communicates with the main channel 52 when the third valve 72 is opened. The auxiliary channel 7 also directly communicates with the water tank 1.

In operation, when one of the hollow buoyant bodies 4 enters the second section 522 of the main channel 52 through the inner gate 53, the third valve 72 is opened after the inner gate 53 is completely closed, thus water in the water tank 1 enters the second section 522 of the main channel 52 through the third pipe 71, a water pressure in the second section is balanced with a water pressure in the water tank., The hollow buoyant bodies 4 located in the second section are not sucked by the negative pressure of the second section, and can enter the water tank 1 more easily under a force applied by other hollow buoyant bodies which have already entered in the water tank.

In addition, a water replenishing port 17 is arranged at an upper portion of the water tank 1, water can be filled into the water tank 1 from the water replenishing port 17, and a highest liquid level 171 of the water tank 1 is guaranteed.

Since the outlet 12 does not adopt a sealing structure, the outlet 12 is higher than the liquid level in the water tank 1.

In order to fully illustrate the implementation of the present invention, reference will now be made to the following specific data.

The hollow buoyant bodies 4 are set to be five evenly distributed balls, and the weight is G.

The height H of the water tank 1 is set to be 5 meters, the length L to be 6 meters, and the width W to be 3 meters.

The hollow buoyant body 4 is set as a cylinder, with a length of 1.2 meters, a diameter of 1 meter, so the volume V1 of the hollow buoyant body 4 is 1.2 cubic meters, the buoyancy of a single hollow buoyant body 4 in the water tank 1 is F1=ρgV1≈1.2 N (newtons), and the buoyancy is proportional to the volume of the buoyancy ball. After the large water tank is filled with water, the annular structure composed of five floating balls is always in an unbalanced state and the force can not be blocked.

The resistance of a part of the hollow buoyant body entering the water tank is the buoyancy F2=ρgV2≈V2 when a part of the hollow buoyant body entering the water (V2 is a volume of the part of the hollow buoyant body entering the water). When the hollow buoyant body enters the water, V2<V1, therefore, F2<F1+G, and the hollow buoyant body can enter the water tank smoothly. In addition, due to the aid of the pressure gas storage tank, the hollow buoyant body can smoothly enter water even if friction loss of other parts of the whole device occurs, so that continuous operation of the whole device is guaranteed, and continuous power output is achieved.

The present invention makes full use of the buoyancy of water, the output of rotary power is realized by using the hollow buoyant bodies, compared with the existing device for converting potential energy into kinetic energy of water by utilizing the water level height difference, the conversion efficiency is high, the torque is large, the device is not limited by topography, which is easier to implement.

While the invention has been described in terms of several exemplary embodiments, those skilled on the art will recognize that the invention can be practiced with modification within the spirit and scope of the appended claims. Such as increasing the length of the supporting rods, changing the density of the water, injecting compressed gas into the hollow buoyant spheres, increasing the support rods and buoyant balls to six or eight, etc. (when multiple hollow buoyant bodies are used, the included angle between adjacent supporting rods may be calculated according to the following formula: the included angle α=360/n, n is the number of hollow floating balls), and the design effect of the invention can also be achieved. In addition, it is noted that, the Applicant's intent is to encompass equivalents of all claim elements, even if amended later during prosecution.

1. A buoyancy working device, comprising:
a water tank (1) having a side wall defining an opening;
two arc-shaped guide rails (13) configured in the water tank, each connecting an upper edge, a lower edge and a side edge/wall of the opening, the side wall also defining an inlet (11) below the lower edge and an outlet (12) above the upper edge;
a rotating shaft (2) fixed on an outside of the side wall of the water tank;
at least five support rods (3) extending perpendicularly and evenly from the rotating shaft;
an annular sealing ring (31) connecting with the at least five support rods, configured around the rotating shaft, and slidably and sealingly connected with the two arc-shaped guide rails to seal the opening;
hollow buoyant bodies (4) each connecting with a corresponding end of the at least five support rods or connecting with the sealing ring and being capable of passing through the inlet and the outlet; and
a gate assembly (5) configured in the water tank to facilitate the hollow buoyant bodies to enter the water tank, the gate assembly being close to the inlet;
wherein the gate assembly comprises:
a cylindrical main channel (52) having an inner gate (53) and an outer gate (54) and allowing the hollow buoyant bodies to pass through;
a driving device (59) configured for driving the inner gate and the outer gate to open and close;
a pressure gas storage tank (51) being capable of communicating with the main channel through a first pipe (55) and a second pipe (56), the first pipe (55) being configured close to the inner gate, and the second pipe (56) being configured close to the outer gate;
a first one-way valve (57) connected to the first pipe and configured to allow gas to enter the pressure gas storage tank from the main channel; and
a second one-way valve (58) connected to the second pipe and configured to allow gas to enter the main channel from the pressure gas storage tank;
wherein when a hollow buoyant body approaches the outer gate, the driving device opens the outer gate and allows the hollow buoyant body to enter the main channel; when the hollow buoyant body completely enters the main channel, the driving device closes the outer gate; when the ball moves in the main channel, the first one-way valve opens, and gas in the main channel enters the pressure gas storage tank under action of the hollow buoyant body; then the driving device opens the inner gate; after the inner gate fully opens, the second one-way valve is opened, and high-pressure gas in the pressure gas storage tank enters the main channel, pushing the hollow buoyant body to pass the inner gate and enter the water tank; the hollow buoyant body entering the water tank moves upward due to the buoyancy of water, so as to further drive the rotating shaft to rotate and drive other hollow buoyant bodies that have not entered the water tank to move toward the inlet.

2. The buoyancy working device according to claim 1, wherein the outer gate is arranged near or at an outer end (523) of the main channel, and the inner gate is arranged near an inner end (524) of the main channel; the main channel is divided into a first section (521) between the inner gate and the outer gate, and a second section (522) between the inner gate and the inner end (524) of the main channel.

3. The buoyancy working device according to claim 2, further comprising an auxiliary channel (7) configured near the main channel and capable of communicating with the second section of the main channel via a third pipe (71); the auxiliary channel communicates with the water tank, and a third valve (72) is configured for controlling water flow through the third pipe.

4. The buoyancy working device according to claim 3, wherein when one of the hollow buoyant bodies enters the second section of the main channel through the inner gate, the third valve is opened after the inner gate is completely closed, thus water in the water tank enters the second section of the main channel through the third pipe, and a water pressure in the second section is balanced with a water pressure in the water tank.

5. The water energy utilization device according to claim 3 wherein a water replenishing port (17) is provided in the water tank.

6. The water energy utilization device according to claim 5, wherein the outlet is above a highest level of liquid in the water tank.

7. The water energy utilization device according to claim 6, wherein the inner gate and the outer gate are both normally closed gates.
